(19) United States
(12) Patent Application Publication
(10) Pub. No.: US 2002/0122035 A1
(43) Pub. Date: Sep. 5, 2002

(54) Method and system for parameterized normal predictive encoding

(76) Inventor: Francis M.L. Ng, Sunnyvale, CA (US)

Correspondence Address: Sanjeet K. Dutta, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/751,816

(22) Filed: Dec. 29, 2000

(51) Int. Cl. G06T 17/00

(52) U.S. Cl. 345/420

(57) ABSTRACT

A method and system for parameterized normal predictive encoding is disclosed. In one embodiment, the method comprises performing parameterization on three-dimensional graphics model geometric data. Scalar quantization is performed on the three-dimensional graphics model geometric data. The three-dimensional graphics model geometric data is encoded differentially. Coded and compressed three-dimensional graphics model geometric data is generated.

### FIELD OF THE INVENTION

This invention relates to computer graphics, and more specifically to a method and system that efficiently encode the normals of three-dimensional graphics models.

### BACKGROUND OF THE INVENTION

Surface normal is an indispensable component of geometric data in the rendering of 3D graphics models. Accurately calculated normal can greatly enhance the perceived quality of 3D graphics models. Normals are customarily represented in three 32-bit IEEE floating-point numbers. In state-of-the-art highend graphics rendering, each frame can easily contain 1 million triangles with frame rate about 60 frames/second. Assuming that a normal is associated with each vertex of a triangle (4 bytes/coordinate×3 coordinate/vertex×3 vertices/triangle=36 bytes/triangle), the data rate for uncompressed normal alone can be as much as 2.18 GB/s (ignoring vertex coordinates, colors and texture coordinates). The typical memory bandwidth between main memory and CPU as of today ranges from 800 MB/s to 1 GB/s (AGP 4×). The memory bus bandwidth is a major bottleneck in three-dimensional graphics rendering. Compressing normal is just as important as compressing other geometric data such as vertex coordinates, colors and texture coordinates in cutting down the high data rate of 3D graphics models.

A group known as the Motion Picture Expert Group has been defining an image compression system known as “MPEG4” that compresses images by defining objects in the image with three-dimensional object models. The compressed images can be reconstructed by rendering the scenes using the three-dimensional object models. In MPEG4 standard, a 3D model coding (3DMC) technique is proposed to reduce the data size of the three-dimensional object models. The technique consists of two main components: connectivity encoding and geometry encoding. Connectivity encoding reduces the redundancy inherent to the representations of polyhedral or triangular 3D meshes. For example, one straightforward but inefficient technique to represent a mesh is to represent each triangle in a mesh by direct reference to its 3 vertices. 3DMC first decomposes a mesh into spanning trees of triangles and vertices. These trees are encoded separately in a lossless manner. The geometry encoding of 3DMC performs lossy compression on the geometric data associated with each vertex location, and possibly, vertex normals, colors, and texture coordinates. The normal encoding technique proposed in MPEG4 3DMC is discussed in this document as a prior-art.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a functional block diagram of a prior art normal encoding technique that adopts a vector quantization (VQ) approach;

FIG. 2 illustrates a functional block diagram 200 of prior art vector quantization normal predictive decoding;

FIG. 3 illustrates a computer system 2000 representing an integrated multi-processor, in which elements of the present parameterized normal predictive encoder and decoder may be implemented;

FIG. 4 illustrates a functional block diagram of parameterized normal predictive encoding according to one embodiment of the present invention;

FIG. 5 illustrates a functional block diagram of parameterized normal predictive decoding according to one embodiment of the present invention;

FIG. 6 is a flow diagram of the process for parameterized normal predictive encoding; and

FIG. 7 is a flow diagram of the process for parameterized normal predictive decoding.

### DETAILED DESCRIPTION

A method and system for parameterized normal predictive encoding is disclosed. In one embodiment, the method comprises performing parameterization on three-dimensional graphics model geometric data. Scalar quantization is performed on the three-dimensional graphics model geometric data. The three-dimensional graphics model geometric data is encoded differentially. Coded and compressed three-dimensional graphics model geometric data is generated.

In the following description, for purposes of explanation, specific nomenclature is set forth to provide a thorough understanding of the present invention. However, it will be apparent to one skilled in the art that these specific details are not required in order to practice the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CDROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### MPEG4 3DMC Normal Encoding

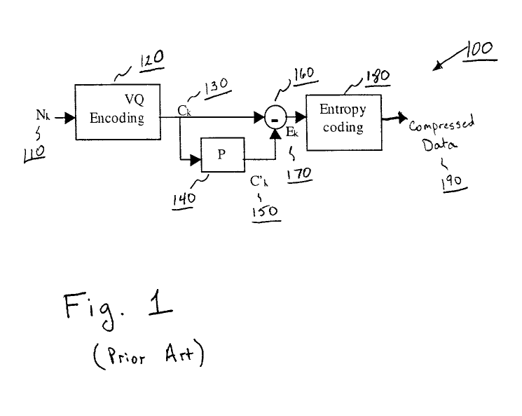

FIG. 1 illustrates a functional block diagram 100 of a prior art normal encoding technique (proposed in MPEG4 3DMC) that adopts a vector quantization (VQ) approach. Each normal is mapped to a codebook index, which is differentially encoded, and then followed by entropy coding. Normalized normals Nₖ=(n^{(k)}ₓ,n^{(k)}_{y},n^{(k)}_{z}) 110 can be thought of as a point in one of the 8 octants on a unit radius sphere. Surface normals in general can point in any direction. One assumption of this technique is that surface normals are uniformly distributed over the unit sphere. Since each octant on the sphere is symmetrical, representing the locations of normals in one octant is sufficient to represent any normals in the unit sphere if the octant to which the normals belong is known.

Since each octant is symmetrical, the choice of the octant where encoding takes place does not matter. Under VQ normal encoding scheme, all the encoding takes place in the positive octant, in the region bounded by:

x≧0

y≧0

z≧0

x²+y²+z²=1

At processing block 120, VQ encoding is performed. The absolute values of each coordinate of the points on the sphere are taken, so that each “absolute” normal Nₖ′=(n^{(k)}′ₓ,n^{(k)}′_{y},n^{(k)}′_{z}) now lies on the positive octant. Then Nₖ′ is mapped to an index iₖ∈J≡{0,1,2, . . . 2^{2Nmax}−1}, via the mapping (hereafter known as VQ encoding) defined as follows:

$$\begin{matrix}{i}_{k} = 2 {Mi}_{y}^{( k )} - {i}_{y}^{{( k )}^{2}} + 2 {i}_{x}^{( k )} + {U}_{k} \\ where M = {2}^{{N}_{max}} \\ {i}_{x}^{( k ) ′} = floor ( \frac{{n}_{x}^{( k ) ′} M}{{n}_{x}^{( k ) ′} + {n}_{y}^{( k ) ′} + {n}_{z}^{( k ) ′}} ) \\ {i}_{y}^{( k ) ′} = floor ( \frac{{n}_{y}^{( k ) ′} M}{{n}_{x}^{( k ) ′} + {n}_{y}^{( k ) ′} + {n}_{z}^{( k ) ′}} ) \\ {i}_{z}^{( k ) ′} = floor ( \frac{{n}_{z}^{( k ) ′} M}{{n}_{x}^{( k ) ′} + {n}_{y}^{( k ) ′} + {n}_{z}^{( k ) ′}} ) \\ {i}_{x}^{( k )} = \{ \begin{matrix}{i}_{x}^{( k ) ′} & {i}_{x}^{( k ) ′} \neq M \\ {i}_{x}^{( k ) ′} - 1 & {i}_{x}^{( k ) ′} = M\end{matrix} \\ {i}_{y}^{( k )} = \{ \begin{matrix}{i}_{y}^{( k ) ′} & {i}_{x}^{( k ) ′} + {i}_{y}^{( k ) ′} \neq M \\ {i}_{y}^{( k ) ′} - 1 & {i}_{x}^{( k ) ′} + {i}_{y}^{( k ) ′} = M\end{matrix} \\ {U}_{k} = \{ \begin{matrix}1 & M - {i}_{x}^{( k )} - {i}_{y}^{( k )} - {i}_{z}^{( k )} = 2 \\ 0 & M - {i}_{x}^{( k )} - {i}_{y}^{( k )} - {i}_{z}^{( k )} \neq 2\end{matrix}\end{matrix}$$

The index iₖ belonging to the normal Nₖ′, which can be represented by 2Nₘₐₓ bits, is concatenated with its associated 3-bit octant code, oₖ, to form the normal code Cₖ 130 which is represented by 2Nₘₐₓ+3 bits. Under VQ normal encoding technique, three of the normal representation bits, oₖ, are used to encode the octant to which the Nₖ belongs (determined by the three sign bits of am the x,y,z components of Nₖ). The rest of the normal representation bits, iₖ, are used to represent the location of a normal in the octant to which it belongs.

At processing block 140, Cₖ 130 is passed into a predictor which generates a predicted normal code C′ₖ 150 from actual normal codes of previously traversed vertices. At summation block 160, the difference between the actual normal code Cₖ 130 and the predicted normal code C′ₖ 150 is generated as Eₖ 170. At processing block 180, Eₖ 170 is entropy coded and compressed data 190 is output. Like vertex positions, vertex normals in the same neighborhood show geometric similarity. Except at locations such as hard edges, neighboring normals tend to point in similar directions. Such locality characteristics can be exploited again in the encoding of the normal codes obtained above, just as vertex positions. Because proximity in the vertex spanning tree often implies geometric proximity of the corresponding vertices, we only need to encode the difference Eₖ 170 between the actual normal code Cₖ 130 of a particular vertex k and the predicted normal codes C′ₖ 150 constructed from actual normal codes of previously traversed vertices of the vertex spanning tree. These corrective terms Eₖ 170 have on average smaller magnitude and thus less entropy than absolute codes. The error terms are then entropy coded.

MPEG4 3DMC Normal Decoding

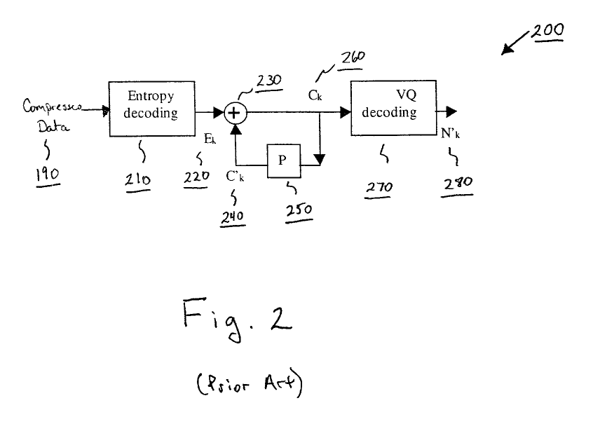

FIG. 2 illustrates a functional block diagram 200 of a prior art vector quantization normal predictive decoding (proposed in MPEG4 3DMC). Decoding the compressed normal is in principle the reverse of the encoding process. At processing block 210, compressed data 190 is entropy decoded, resulting in the generation of Eₖ220, representing the error between the actual normal code Cₖ260 and the predicted normal code Cₖ240. At summation block 230, Eₖ, 220 is added to C′ₖ240 to generate the normal code Cₖ 260. At processing block 250, a predicted value C′ₖ240 is generated from the normal code Cₖ260. At processing block 250, a predicted value Cₖ 240 is generated from the normal code Cₖ260. At processing block 270, VQ decoding is performed on Cₖ260 to generate Nₖ280. Nₖ280 is Nₖ 110 after being coded and then decoded. The actual normal code Cₖ 260 corresponding to a particular vertex k is constructed by adding its associated normal code error Eₖ 220 to the predicted normal codes Cⁱₖ 240 obtained from normal codes of previously traversed vertices in the vertex spanning tree.

The normal code Cₖ 260 consists of the octant code, Oₖ, which represents the octant to which the normal Nₖ 110 belongs, and the index, iₖ, to which the normal Nₖ 110 is mapped. The decoder maps the index iₖ back to the reproduction vector N^{I}ₖ=(n^{i(k)}ₓ,n^{i(k)}_{y},n^{i(k)}_{z}) called codewords, via the following mapping (hereafter known as VQ decoding):

n′ₓ^{(k)}=(3xₖ+1+Uₖ)/M

n′_{y}^{(k)}=(3yₖ+1+Uₖ)/M

n′_{z}^{(k)}=3−n′ₓ^{(k)}−n′_{y}^{(k)}

where M=2^{Nmax}

yₖ=floor(M−\sqrt{M²−iₖ})

xₖ=floor((iₖ+yₖ(yₖ−2M))/2)

Uₖ=(iₖ+yₖ(yₖ−2M))mod 2

It can be shown that the above mapping makes sure that for every iₖ≠iⱼ, N′ₖ≠N′ⱼ. The octant code oₖ is then extracted to restore the sign bits of the reproduction vector N′ₖ.

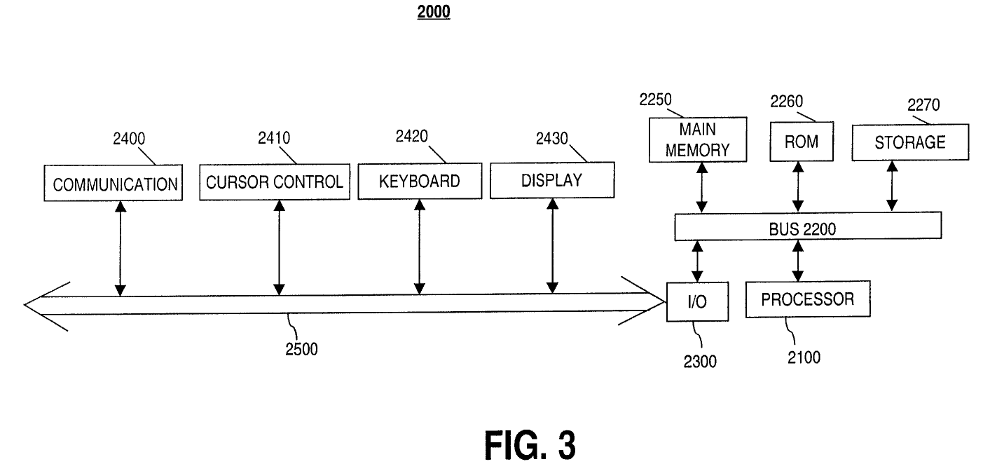

FIG. 3 illustrates a computer system 2000 representing an integrated multi-processor, in which elements of the present parameterized normal predictive encoder and decoder may be implemented. One embodiment of computer system 2000 comprises a system bus 2200 for communicating information, and a processor 2100 coupled to bus 2200 for processing information. Computer system 2000 further comprises a random access memory (RAM) or other dynamic storage device 2250 (referred to herein as main memory), coupled to bus 2200 for storing information and instructions to be executed by processor 2100. Main memory 2250 also may be used for storing temporary variables or other intermediate information during execution of instructions by processor 2100. Computer system 2000 also may include a read only memory (ROM) and/or other static storage device 2260 coupled to bus 2200 for storing static information and instructions used by processor 210.

A data storage device 2270 such as a magnetic disk or optical disc and its corresponding drive may also be coupled to computer system 2000 for storing information and instructions. Computer system 2000 can also be coupled to a second I/O bus 2500 via an I/O interface 2300. A plurality of I/O devices may be coupled to I/O bus 2500, including a display device 2430, an input device (e.g., an alphanumeric input device 2420 and/or a cursor control device 2410). For example, video and graphics clips and related information may be presented to the user on the display device 2430.

The communication device 2400 is for accessing other computers (servers or clients) via a network. The communication device 2400 may comprise a modem, a network interface card, or other well known interface device, such as those used for coupling to Ethernet, token ring, or other types of networks.

### Parameterized Normal Predictive Encoding

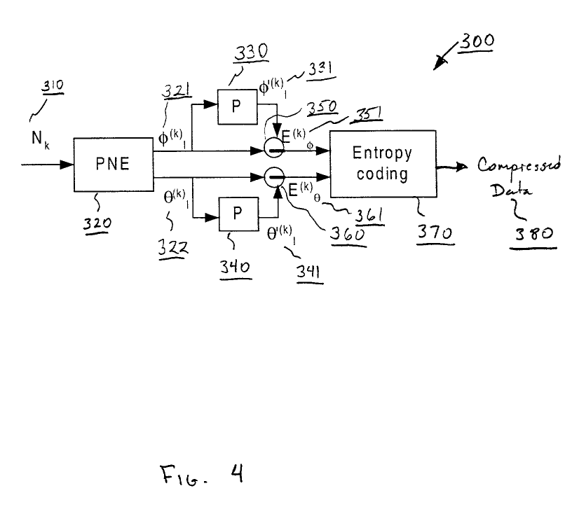

FIG. 4 illustrates a functional block diagram 300 of parameterized normal predictive encoding according to one embodiment of the present invention. The functions described herein, may be performed by an apparatus such as that of FIG. 3. At processing block 320, normal invention is encoded in its parameterized form. Normalized normals Nₖ=(n^{(k)}ₓ,n^{(k)}_{y},n^{(k)}_{z}), 310 belonging to a particular vertex k, have unit length and can be mapped easily into spherical coordinates as follows:

φ^{(k)}=sin⁻¹n_{y}^{(k)}

θ^{(k)}=tan⁻¹(n_{z}^{(k)}/nₓ^{(k)})

θ^{(k)} is the angle about the y-axis; φ^{(k)} is the longitudinal angle from the y=0 plane. Note that φ^{(k)} goes from −π/2 to π/2 and θ^{(k)} goes from −π to π. φ^{k} and θ^{(k)}, are first normalized into the range from −0.5 to 0.5 to form φ^{(k)}ₙ and θ^{(k)}ₙ and then uniformly quantized to integers φ_{I}^{(k)} 321 and φ_{I}^{(k)} 322 separately as follows:

θ_{I}^{(k)}=[θ^{(k)}·2^{b}^{_{θ}}/2π]

φ_{I}^{(k)}=[φ^{(k)}·2^{b}^{_{φ/π]}}

The mapping from Nₖ 310 to φ_{I}^{(k)} 321 and θ_{I}^{(k)} 322 is known hereafter as parameterized normal encoding (PNE). b₁₀₀ and b_{θ} are total number of bits used to represent φ^{(k)}ₙ and θ^{(k)}ₙ, or the quantization precisions of φ^{(k)}ₙ and θ^{(k)}ₙ in number of bits. So 2^{-bφ} and 2^{-bθ} are the quantization steps. Note that since φ^{(k)}ₙ and θ^{(k)}ₙ can take any value in [−0.5, 0.5], φ_{I}^{(k)} 321 can be any bφ-bit integer from −2^{bφ-1} to 2^{bφ-1}−1 in 2's complement arithmetic; θ_{I}^{(k)} 322 can be any b₇₄-bit integer from −2^{bθ-1} to 2^{bθ-1}−1 in 2's complement arithmetic.

φ_{I}^{(k)} 321 is passed onto processing block 330, where the predicted value of φ_{I}^{(k)} 321 is generated as φ′_{I}^{(k)} 331. θ_{I}^{(k)} 322 is passed onto processing block 340, where the predicted value of θ_{I}^{(k)} 322 is generated as θ′_{I}^{(k)} 341.

At summation blocks 350 and 360, φ_{I}^{(k)} 321 and θ_{I}^{(k)} 322 are then differentially encoded respectively. To be more specific, the error E_{φ}^{(k)} 351 (E^{(k)}_{θ}) 361 between the actual φ_{I}^{(k)} 321 (θ_{I}^{(k)} 332) of a particular vertex k and the predicted φ_{I}′^{(k)} 331 (θ_{I}′^{(k)} 341) constructed from actual ones of previously traversed vertices of the vertex spanning tree. These corrective terms E^{(k)}_{φ} 351 and E^{(k)}_{θ} 361, again, having on average smaller magnitude and thus less entropy than φ_{I}^{(k)} 321 and θ_{I}^{(k)} 322, are combined together to be entropy coded at processing block 370. The entropy coding may be Huffman coding, arithmetic coding or LempelZiv coding, although other methods of entropy coding are also contemplated to be within the scope of the present invention. Compressed data is generated after the entropy coding is complete.

### Parameterized Normal Predictive Decoding

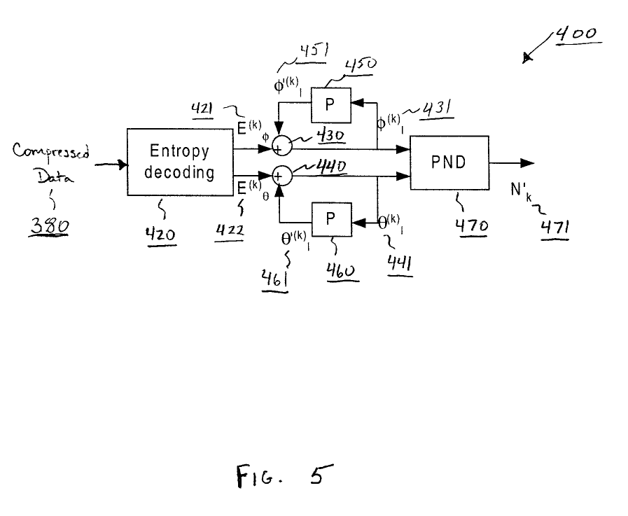

FIG. 5 illustrates a functional block diagram 400 of parameterized normal predictive decoding according to one embodiment of the present invention. The functions described herein, may be performed by an apparatus such as that of FIG. 3. Parameterized normal decoding is in principle the reverse of the encoding process. At processing block 420, compressed data 380 is entropy decoded, resulting in the generation of E^{(k)}_{φ} 421 and E^{(k)}_{θ} 422. E^{(k)}_{φ} 421 (E^{(k)}_{θ} 422) represent the error between the predicted values φ′_{I}^{(k)} 451 (θ′_{I}^{(k)} 461) and the actual values φ_{I}^{(k)} 431 (θ_{I}^{(k)} 441) of previously traversed vertices in the vertex spanning tree. At summation block 430, E_{φ}^{(k)} 421 is added to φ^{(k)} 451 to generate the parameterized normal code φ_{I}^{(k)} 431. At summation block 440, E_{θ}^{(k)} 421 is added to θ_{I}^{(k)} 461 to generate parameterized normal code θ_{I}^{(k)} 441. At processing blocks 450 and 460, predicted values φ′_{I}^{(k)} 451 and θ′_{I}^{(k)} 461 are generated from normal codes φ_{I}^{(k)} 431 and θ_{I}^{(k)} 441, respectively.

At processing block 470, φ,^{(k)} 431 and θ_{I}^{(k)} 441 are then dequantized and unnormalized to give φ^{(k)} and θ^{(k)} as follows:

$$\begin{matrix}{θ}^{( k ) ′} = \frac{2 π {θ}_{l}^{( k )}}{{2}^{{b}_{0}}} \\ {φ}^{( k ) ′} = \frac{{πφ}_{l}^{( k )}}{{2}^{{b}_{φ}}}\end{matrix}$$

The parameterized normal values φ^{(k)′} and θ^{(k)′} are then mapped back to rectangular normal coordinates N′ₖ=(n′^{(k)}ₓ,n′^{(k)}_{y},n′^{(k)}_{z}) 471 as follows:

n′_{y}^{(k)}=sinφ^{(k)}′

n′ₓ^{(k)}=cosθ^{(k)}′cosφ^{(k)}′

n′_{z}^{(k)}=sinθ^{(k)}′cosφ^{(k)}′

The mapping from φ^{(k)}_{I} and θ^{(k)}_{I} to N′ₖ 471 is known hereafter as parameterized normal decoding (PND).

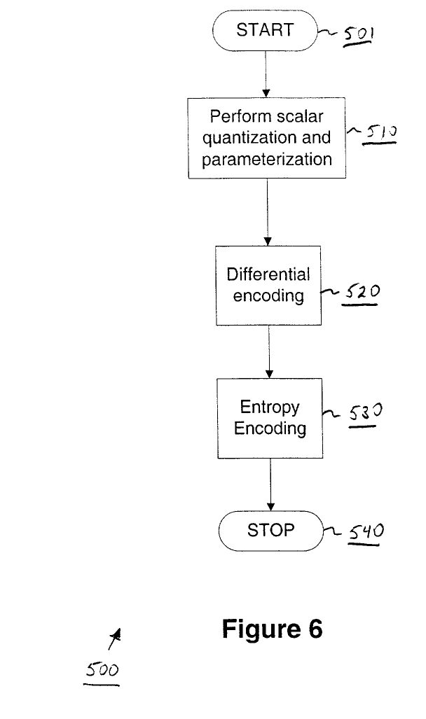

FIG. 6 is a flow diagram of the process for parameterized normal predictive encoding. The process 500 begins at start block 501. At processing block 510, normalized normal Nₖ 310 is first parameterized and then quantized to give φ^{(k)}_{I} 321 and θ^{(k)}_{I} 332 using the parameterized normal encoding technique described above. Flow continues to processing block 520, where φ_{I}^{(k)} 321 and θ_{I}^{(k)} 322 are differentially encoded, such that the errors E^{(k)}_{φ} 351 and E^{(k)}_{φ} 361 are formed by subtracting the predicted values φ_{I}′^{(k)} 331 and θ_{I}′^{(k)} 341 from the actual ones φ_{I}^{(k)} 321 and θ_{I}^{(k)} 322 of previously traversed vertices. At processing block 530, the errors E^{(k)}_{φ} 351 and E^{(k)}_{θ} 361 are combined together to be entropy coded. Compressed and coded data 380 results. The process completes at block 540.

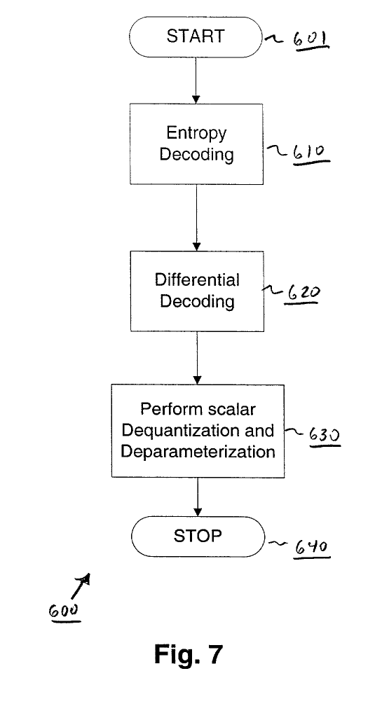

FIG. 7 is a flow diagram of the process for parameterized normal predictive decoding. The process 600 begins at start block 601. At processing block 610, compressed data 380 is entropy decoded to give E^{(k)}_{φ} 421 and E^{(k)}_{θ} 422. Flow continues to processing block 620, where E^{(k)}_{φ} 421 and E^{(k)}_{θ} 422 are differentially decoded. The error values E^{(k)}_{φ} 421 and E^{(k)}_{θ} 422 are added to the predicted values φ_{I}^{(k)} 451 and θ_{I}^{(k)} 461 of previously traversed vertices in the vertex spanning tree to give the actual values φ_{I}^{(k)} 431 and θ_{I}^{(k)} 441. At processing block 630, φ_{I}^{(k)} 431 and θ_{I}^{(k)} 441 are then dequantized, unnormalized and mapped back to the reconstruction normal N_{K} 447 using the parameterized normal decoding technique described above. The process completes at block 640.

A method and system for parameterized predictive normal encoding and decoding are disclosed. Generally, a parameterized normal prediction coding scheme in which scalar quantization is done to each individual spherical coordinate of the normals is described. The quantized spherical coordinates are then differentially encoded and entropy coded. Although the present invention has been described with respect to specific examples and subsystems, it will be apparent to those of ordinary skill in the art that the invention is not limited to these specific examples or subsystems but extends to other embodiments as well. The present invention includes all of these other embodiments as specified in the claims that follow.

I claim:

1). A method, comprising:
performing parameterization on three-dimensional graphics model geometric data;
performing scalar quantization on the three-dimensional graphics model geometric data;
encoding the three-dimensional graphics model geometric data differentially; and
generating coded and compressed three-dimensional graphics model geometric data.

2). The method of claim 1, wherein the three-dimensional graphics model geometric data includes normalized normal vectors.

3). The method of claim 2, wherein performing parameterization further comprises mapping the normalized normal vectors into actual spherical coordinate values.

4). The method of claim 3, wherein performing scalar quantization further comprises generating actual quantized spherical coordinate values.

5). The method of claim 4, wherein encoding the three-dimensional graphics model geometric data differentially further comprises:
generating predicted quantized spherical coordinate values from at least one actual previously quantized spherical coordinate value; and
generating error values by subtracting the predicted quantized spherical coordinate values from the actual quantized spherical coordinate values.

6). The method of claim 5, further comprising encoding the error values using entropy encoding.

7). The method of claim 6, wherein the coded and compressed data is Motion Pictures Experts Group 4, 3 Dimension Model Coded (MPEG4 3DMC).

8). A system, comprising:
means for performing parameterization on three-dimensional graphics model geometric data;
means for performing scalar quantization on the three-dimensional graphics model geometric data;
means for encoding the three-dimensional graphics model geometric data differentially; and
means for generating coded and compressed three-dimensional graphics model geometric data.

9). The system of claim 8, wherein the three-dimensional graphics model geometric data includes normalized normal vectors.

10). The system of claim 9, wherein the means for performing parameterization further comprises means for mapping the normalized normal vectors into actual spherical coordinate values.

11). The system of claim 9, wherein performing scalar quantization further comprises generating actual quantized spherical coordinate values.

12). The system of claim 11, wherein the means for encoding the three-dimensional graphics model geometric data differentially further comprises:
means for generating predicted quantized spherical coordinate values from at least one actual previously quantized spherical coordinate value; and
means for generating error values by subtracting the predicted quantized spherical coordinate values from the actual quantized spherical coordinate values.

13). The system of claim 12, further comprising means for encoding the error values using entropy encoding.

14). The system of claim 13, wherein the coded and compressed data is Motion Pictures Experts Group 4, 3 Dimension Model Coded (MPEG4 3DMC).

15). A computer-readable medium having stored thereon a plurality of instructions, said plurality of instructions when executed by a computer, cause said computer to perform:
performing parameterization on three-dimensional graphics model geometric data;
performing scalar quantization on the three-dimensional graphics model geometric data;
encoding the three-dimensional graphics model geometric data differentially; and
generating coded and compressed three-dimensional graphics model geometric data.

16). The computer-readable medium of claim 15 having stored thereon additional instructions, said additional instructions when executed by a computer, cause said computer to further perform normalizing normal vectors from the three-dimensional graphics model geometric data.

17). The computer-readable medium of claim 16 having stored thereon additional instructions, said additional instructions when executed by a computer for performing parameterization, cause said computer to further perform mapping the normalized normal vectors into actual spherical coordinate values.

18). The computer-readable medium of claim 16 having stored thereon additional instructions, said additional instructions when executed by a computer for performing quantization, cause said computer to further perform generating actual quantized spherical coordinate values

19). The computer-readable medium of claim 18 having stored thereon additional instructions, said additional instructions when executed by a computer for encoding the three-dimensional graphics model geometric data differentially, cause said computer to further perform:
generating predicted quantized spherical coordinate values from at least one actual previously quantized spherical coordinate value; and
generating error values by subtracting the predicted quantized spherical coordinate values from the actual quantized spherical coordinate values.

20). The computer-readable medium of claim 19 having stored thereon additional instructions, said additional instructions when executed by a computer, cause said computer to further perform encoding the error values using entropy encoding.

21). The computer-readable medium of claim 20, wherein the coded and compressed data is Motion Pictures Experts Group 4, 3 Dimension Model Coded (MPEG4 3DMC).

22). A system, comprising:
a parameterized normal encoder comprising,
a processor, wherein the processor performs scalar quantization and parameterization on three-dimensional graphics model geometric data; and
a storage device connected to the processor for storing instructions executed by the processor;
a predictor connected to the parameterized normal encoder; and
an entropy encoder connected to the predictor; wherein the system generates coded and compressed three-dimensional graphics model geometric data.

23). The system of claim 22, wherein the three-dimensional graphics model geometric data includes normalized normal vectors.

24). The system of claim 23, wherein the processor maps the normalized normal vectors into actual spherical coordinate values and quantizes the actual spherical coordinate values into actual quantized spherical coordinate values.

25). The system of claim 24, wherein the predictor generates predicted quantized spherical coordinate values from at least one actual previously quantized spherical coordinate value.

26). The system of claim 25, wherein the processor generates error values by subtracting the predicted quantized spherical coordinate values from the actual previously quantized spherical coordinate values.

27). The system of claim 25, wherein the entropy encoder encodes the error values using entropy encoding.

28). The system of claim 27, wherein the coded and compressed data is Motion Pictures Experts Group 4, 3 Dimension Model Coded (MPEG4 3DMC).

29). A method, comprising:
generating actual quantized spherical coordinate values by adding error values to predicted quantized spherical coordinate values;
performing deparameterization and scalar dequantization on the actual quantized spherical coordinate values; and
generating decompressed three-dimensional graphics model geometric data from the dequantized spherical coordinate values.

30). The method of claim 29, wherein performing deparameterization and scalar dequantization further comprises mapping spherical coordinate values into decoded, dequantized, unnormalized normal vectors.

31). The method of claim 30, further comprising decoding compressed three-dimensional graphics model geometric data using entropy decoding, wherein the compressed three-dimensional graphics model geometric data contains error values.

32). The method of claim 31, wherein generating actual quantized spherical coordinate values further comprises:
adding error values to the predicted quantized spherical coordinate values to generate the actual quantized spherical coordinate values.

33). The method of claim 32, wherein the compressed three-dimensional graphics model geometric data is MPEG4 3DMC.

34). A system, comprising:
means for generating actual quantized spherical coordinate values by adding error values to predicted quantized spherical coordinate values;
means for performing deparameterization and scalar dequantization on the actual quantized spherical coordinate values; and
means for generating decompressed three-dimensional graphics model geometric data from the dequantized spherical coordinate values.

35). The system of claim 34, wherein the means for performing deparameterization and scalar dequantization further comprises means for mapping spherical coordinate values into decoded, dequantized, unnormalized normal vectors.

36). The system of claim 35, further comprising means for decoding compressed three-dimensional graphics model geometric data using entropy decoding, wherein the compressed three-dimensional graphics model geometric data contains error values.

37). The system of claim 36, wherein the means for generating actual quantized spherical coordinate values further comprises:
means for adding error values to predicted quantized spherical coordinate values to generate the actual quantized spherical coordinate values.

38). The system of claim 37, wherein the compressed three-dimensional graphics model geometric data is MPEG4 3DMC.

39). A computer-readable medium having stored thereon a plurality of instructions, said plurality of instructions when executed by a computer, cause said computer to perform:
generating actual quantized spherical coordinate values by adding error values to predicted quantized spherical coordinate values;
performing deparameterization and scalar dequantization on the actual quantized spherical coordinate values; and
generating three-dimensional graphics model geometric data from the dequantized spherical coordinate values.

40). The computer-readable medium of claim 39 having stored thereon additional instructions, said additional instructions when executed by a computer for performing deparameterization and scalar dequantization, cause said computer to further perform mapping spherical coordinate values into decoded, dequantized, unnormalized normal vectors.

41). The computer-readable medium of claim 40 having stored thereon additional instructions, said additional instructions when executed by a computer, cause said computer to further perform decoding compressed three-dimensional graphics model geometric data using entropy decoding, wherein the compressed three-dimensional graphics model geometric data contains error values.

42). The computer-readable medium of claim 41 having stored thereon additional instructions, said additional instructions when executed by a computer for generating actual spherical coordinate values, cause said computer to further add error values to predicted quantized spherical coordinate values to generate the actual quantized spherical coordinate values.

43). The computer-readable medium of claim 42, wherein the compressed three-dimensional graphics model geometric data is MPEG4 3DMC.

44). A system, comprising:
a parameterized normal decoder comprising,
a processor, wherein the processor performs deparameterization and scalar dequantization on compressed three-dimensional graphics model geometric data; and
a storage device connected to the processor for storing instructions executed by the processor;
a predictor connected to the parameterized normal decoder; and an entropy decoder connected to the predictor.

45). The system of claim 44, wherein the compressed three-dimensional graphics model geometric data includes error values.

46). The system of claim 45, wherein the processor maps actual spherical coordinate values into reconstructed unnormalized, dequantized normal vectors.

47). The system of claim 46, wherein the predictor generates predicted quantized spherical coordinate values from at least one actual previously quantized spherical coordinate value.

48). The system of claim 47, wherein the processor generates actual quantized spherical coordinate values by adding error values to the predicted quantized spherical coordinate values.

49). The system of claim 48, wherein the entropy decoder decodes the error values using entropy decoding.
